(19) United States
(12) Patent Application Publication
(10) Pub. No.: US 2019/0349476 A1
(43) Pub. Date: Nov. 14, 2019

(54) CALL REJECTION WITH LOCATION INFORMATION

(71) Applicant: QUALCOMM Incorporated, San Diego, CA (US)

(72) Inventors: Arjun Suri, San Diego, CA (US); Ankit Banaudha, Hyderabad (IN); Pranav Krishna Gulati, Kanpur (IN)

(21) Appl. No.: 15/976,202

(22) Filed: May 10, 2018

(51) Int. Cl. H04M 3/436; H04W 4/14; H04W 4/029; H04M 3/42; H04M 1/725

(52) U.S. Cl. CPC H04M 3/436; H04W 4/14; H04W 4/029; H04M 2242/30; H04M 1/72597; H04M 1/72583; H04M 3/42102

(57) ABSTRACT

Methods and apparatuses are disclosed for automatically rejecting an incoming call on mobile device. In addition to automatically rejecting the call, an outgoing text message can be sent manually or automatically that includes information related to a location of the mobile device. The text message can be sent using circuit-switched or packet-switched signaling or protocols.

### BACKGROUND

### Field

This disclosure relates to use of circuit-switched and/or packet-switched communications for mobile wireless devices.

### Background

In many situations, users may not be able to respond to incoming calls on their mobile devices (for example, their mobile phones or tablets, etc.) due to safety, such as when they are driving, or for other reasons. In such situations, mobile phones may include automatic or user-directed responses to the incoming call to indicate that the user is unable to reply, with or without an explanation of the reason. Additionally, many mobile devices are configured to disable or reduce the use of data services in situations where the battery power level of the mobile device is low to extend the use of the device before the battery power is completely used up, as data services using packet-switched communications can be more power hungry than voice or text messaging using circuit-switched communications.

### SUMMARY

In one aspect, a method for sending a text message from a mobile device comprises receiving, at the mobile device, an incoming call from an other device; automatically rejecting, by the mobile device, the incoming call in response to a detection that the mobile device is in an automatic call rejection mode; and sending the text message from the mobile device to the other device, where the text message includes information related to a location of the mobile device. The method can include sending the text message using circuit-switched (CS) signaling. The automatic call rejection mode can include, for example, a driving mode, a power saving mode, a national roaming call rejection mode, or an international roaming call rejection mode, or any combination thereof. In some implementations, sending the text message including information related to a location of the mobile device is performed responsive to a determination that a phone number associated with the other device is included in a contact list of the mobile device. In one example, rejecting the incoming call from the other device by the mobile device comprises displaying via a user interface one or more options associated with automatically rejecting the incoming call, and receiving from the user interface a selection of an option of the one or more options associated with automatically rejecting the incoming call. In one example, the information related to the location of the mobile device can comprise a textual representation of location coordinates associated with the location of the mobile device, or, additionally or alternatively, an image of a map including an indication of the location of the mobile device on the map. The method can also further include determining, by the mobile device, the location of the mobile device.

In another aspect, a mobile device can comprise a transceiver, a memory, and a processor coupled with the transceiver and the memory. The transceiver can be configured to receive an incoming call from an other device. The processor can be configured to automatically reject the incoming call in response to a detection that the mobile device is in an automatic call rejection mode, generate a text message including information related to a location of the mobile device, and send the text message, via the transceiver, to the other device. In one example, the processor can be configured to send the text message using circuit-switched (CS) signaling. In different examples, the automatic call rejection mode can include a driving mode, a power saving mode, a national roaming call rejection mode, or international roaming call rejection mode, or any combination thereof. In one example, the processor configured to send the text message, via the transceiver, to the other device comprises the processor configured to do so responsive to a determination that a phone number associated with the other device is included in a contact list of the mobile device. In one example, the processor configured to automatically reject the incoming call from the other device comprises the processor configured to display via a user interface one or more options associated with automatically rejecting the incoming call and to reject the incoming call responsive to receiving from the user interface a selection of an option of the one or more options associated with automatically rejecting the incoming call. In one example, the mobile device includes a positioning module configured to determine the location of the mobile device.

In one example, an apparatus for sending a text message from a mobile device comprises means for receiving, at the mobile device, an incoming call from an other device; means for automatically rejecting, by the mobile device, the incoming call in response to a detection that the mobile device is in an automatic call rejection mode; and means for sending the text message from the mobile device to the other device, the text message including information related to a location of the mobile device. In one example, the means for sending the text message from the mobile device to the other device comprises means for sending the text message using circuit-switched (CS) signaling. In one example, the means for sending the text message including information related to the location of the mobile device comprises means for sending the text message responsive to a determination that a phone number associated with the other device is included in a contact list of the mobile device. In one example, the means for automatically rejecting the incoming call comprises means for displaying via a user interface one or more options associated with automatically rejecting the incoming call and means for receiving from the user interface a selection of an option of the one or more options associated with automatically rejecting the incoming call. In one example, the apparatus further comprises means for determining the location of the mobile device.

In one example, a non-transitory computer readable medium can store instructions for execution by one or more processors of a mobile device to perform operations comprising receiving, at the mobile device, an incoming call from an other device; automatically rejecting, by the mobile device, the incoming call in response to a detection that the mobile device is in an automatic call rejection mode; and sending the text message from the mobile device to the other device, the text message including information related to a location of the mobile device. In one example, sending the text message from the mobile device to the other device comprises sending the text message using circuit-switched (CS) signaling. In one example, sending the text message including the information related to the location of the mobile device is performed responsive to a determination that the phone number associated with the other device is included in a contact list of the mobile device. In one example, the operations can also further comprise determining, by the mobile device, the location of the mobile device.

### BRIEF DESCRIPTION OF THE DRAWINGS

FIG. 1 illustrates an exemplary mobile device, for example a wireless mobile device receiving an incoming call that sends a text message including information related to a location of the mobile device receiving the incoming call.

FIGS. 2A, 2B, and 2C illustrate examples of a mobile device receiving a call, a display displaying a set of icons to allow a user to select a desired message to send in response to the call, and a display displaying a text message as well as a map indicating a location of the mobile device.

FIG. 3 illustrates an example method of sending a text message from a mobile device.

FIG. 4 illustrates an example protocol stack for communicating using a wireless communications network via, for example, a wireless wide area network (WWAN) transceiver.

FIG. 5 illustrates an example method of implementing the method of FIG. 3.

### DETAILED DESCRIPTION

In some scenarios, a person calling the user of a mobile device wishes simply to inquire about the user's location. The user may wish to share the user's location with the caller without answering the phone call. Hence, for example, if the caller is also using a mobile device, or other device capable of receiving a position of the user or of the mobile device being used by the user via a text message, the user of the mobile device can choose to share the mobile device location with the caller instead of accepting the phone call.

For example, parents calling their children may simply wish to inquire about the location of the child. The child may, instead of accepting the phone call, simply respond by sharing the child's mobile device location with the parent who is calling. In some situations, accepting a phone call on a mobile device may not be safe. One such situation can include when a user is driving a vehicle or is otherwise performing a task in which distraction by a mobile device may be dangerous to the user or others. In such situations, user may respond, using either a user-directed or automatic response, with a text message, for example, “I'm driving,” and may also additionally share the user's mobile device location to indicate to the caller, for example, that the user is on their way or almost there. In some situations, one may simply not be able to reasonably respond to a phone call given their context or environment, for example, where one is in a meeting, or use of mobile devices is otherwise prohibited or restricted. Additionally or alternatively, use of data can, in some situations, be restricted or disabled such that packet-switched (PS) communications are restricted or disabled to save power. In such situations, communications, including Short Message Service (SMS) messages, can be communicated using circuit-switched (CS) communications. Although older versions of SMS communications were often limited to a certain number of characters, for example 160 characters, more recently, SMS can be used to send larger amounts of data, including texts, hyperlinks, and even images.

In various situations, where a user does not wish to respond to an incoming call on a mobile device, or a mobile device is configured to automatically respond to incoming calls, whether due to user choice or preference, safety, or to reduce the power consumption of the mobile device, or any combination thereof, the mobile device can be configured to send a text message including information related to the location of the mobile device receiving the incoming call.

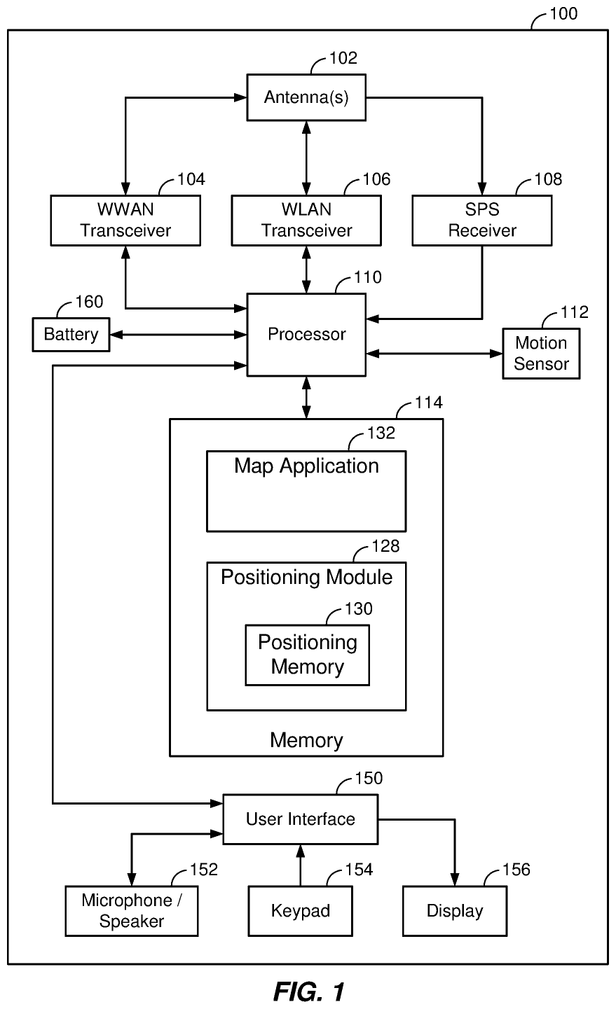

FIG. 1 illustrates an exemplary mobile device, for example a wireless mobile device receiving an incoming call that sends a text message including information related to a location of the mobile device receiving the incoming call. Although the mobile device is a wireless mobile device, for simplicity, it may be referred to simply as a mobile device herein. FIG. 1 is a block diagram illustrating various components of an exemplary mobile device 100. For the sake of simplicity, the various features and functions illustrated in the box diagram of FIG. 1 are connected together using a common bus, which is meant to represent that these various features and functions are operatively coupled together. Those skilled in the art will recognize that other connections, mechanisms, features, functions, or the like, may be provided and adapted as useful to operatively couple and configure an actual mobile device. Further, it is also recognized that one or more of the features or functions illustrated in the example of FIG. 1 may be further subdivided into two or more of the features or functions illustrated in FIG. 1 may be combined.

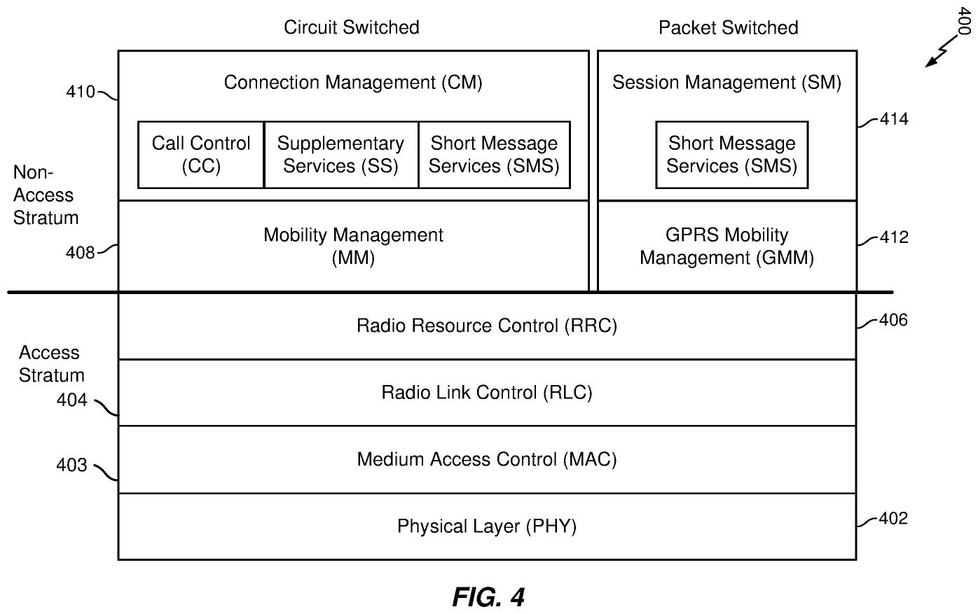

The mobile device 100 may include one or more wireless wide area network (WWAN) transceiver(s) 104 that may be connected to one or more antennas 102. The WWAN transceiver 104 comprises suitable devices, hardware, and/or software for communicating with and/or detecting signals to/from WWAN access points and/or directly with other wireless devices within a network. In one aspect, the WWAN transceiver 104 may comprise a code-division multiple access (CDMA) communication system suitable for communicating with a CDMA network of wireless base stations; however, in other aspects, the wireless communication system may comprise another type of cellular telephony network, such as, for example, TDMA, Long-Term Evolution (LTE), or Global System for Mobile Communications (GSM). Additionally, any other type of wide area wireless networking technologies may be used, for example, WiMAX (IEEE 802.16), etc. In one example, the WWAN transceiver(s) 104 may comprise a communication system capable of communicating with an LTE network of wireless base stations. When communicating using an LTE network, the mobile device 100 may send an SMS messages over an Internet Protocol (IP) Multimedia Subsystem (IMS) or may send the SMS over Serving Gateways (SGs). In one implementation, sending SMS over SGs comprises sending the SMS over circuit-switched (CS) signaling. In one example, the WWAN transceiver(s) 104 may comprise a communication system capable of communicating with a Wideband CDMA (WCDMA) network of wireless base stations and may send the SMS message through the WCDMA network over CS signaling. The WWAN transceiver(s) 104 can be capable of receiving a call. Although not illustrated here for ease of illustration, the WWAN transceiver(s) 104 can be part of a modulator-demodulator (modem) that includes, for example, a physical layer (PHY) for decoding/demodulating the call page as illustrated in FIG. 4. Once the PHY demodulates the call page, the call page can be transmitted to a higher layer, such as a connection management (CM) layer 410 or session management (SM) layer 414 with reference to FIG. 4 in communication with the processor 110, which is involved in displaying an indication of the call to the user via user interface 150 and display 156. Or, alternatively, the mobile device 100 may be configured to automatically respond to the call, and in such a case, the applications layer can take the appropriate action to, for example, reject the call and automatically send a, for example, text message in response.

The mobile device 100 may also include one or more wireless local area network (WLAN) transceivers (such as illustrated WLAN transceiver 106) that may be connected to one or more antennas 102. The WLAN transceiver 106 comprises suitable devices, hardware, and/or software for communicating with and/or detecting signals to/from WLAN access points and/or directly with other wireless devices within a network. In one aspect, the WLAN transceiver 106 may comprise a Wi-Fi (IEEE 802.11x) communication system suitable for communicating with one or more wireless access points; however, in other aspects, the WLAN transceiver 106 comprise another type of local area network or personal area network (PAN). Additionally, any other type of wireless networking technologies may be used, for example, Ultra-Wide Band, Bluetooth, ZigBee, wireless USB, etc.

A satellite positioning system (SPS) receiver 108 may also be included in the mobile device 100. The SPS receiver 108 may be connected to the one or more antennas 102 for receiving satellite signals. The SPS receiver 108 may comprise any suitable hardware and/or software for receiving and processing SPS signals. The SPS receiver 108 requests information and operations as appropriate from the other systems and performs the calculations for determining the position of the mobile device 100 using measurements obtained by any suitable SPS algorithm.

A motion sensor 112 may be coupled to a processor 110 to provide movement and/or orientation information, which is independent of motion data derived from signals, received by the WWAN transceiver 104, the WLAN transceiver 106 and the SPS receiver 108.

By way of example, the motion sensor 112 may utilize an accelerometer (e.g., a microelectromechanical systems device), a gyroscope, a geomagnetic sensor (e.g., a compass), an altimeter (e.g., a barometric pressure altimeter), and/or any other type of movement detection sensor. Moreover, the motion sensor 112 may include a plurality of different types of devices and combine their outputs in order to provide motion information. For example, the motion sensor 112 may use a combination of a multi-axis accelerometer and orientation sensors to provide the ability to compute positions in 2-D and/or 3-D coordinate systems.

The processor 110 may be connected to the WWAN transceiver 104, WLAN transceiver 106, the SPS receiver 108 and the motion sensor 112. The processor 110 may include one or more microprocessors, microcontrollers, and/or digital signal processors that provide processing functions, as well as other calculation and control functionality. The processor 110 may also include memory 114 for storing data and software instructions for executing programmed functionality within the mobile device 100. The memory 114 may be on-board the processor 110 (e.g., within the same integrated circuit package), and/or the memory may be external memory to the processor and functionally coupled over a data bus. The functional details associated with aspects of the disclosure will be discussed in more detail below.

A number of software modules and data tables may reside in memory 114 and be utilized by the processor 110 in order to manage both communications and positioning determination functionality. As illustrated in FIG. 1, memory 114 may include and/or otherwise receive a positioning module 128 and a map application 132 capable of generating a map associated with a computed location determined by the positioning module 128, for example, a map that can then be sent as an image as an SMS message additionally or alternatively to a text message. The memory 114 may also include and/or otherwise receive an application for allowing a user to interact with incoming calls, for example, to enable the user to accept or reject a call. One should appreciate that the organization of the memory contents as shown in FIG. 1 is merely exemplary, and as such the functionality of the modules and/or data structures may be combined, separated, and/or be structured in different ways depending upon the implementation of the mobile device 100. Furthermore, in one embodiment, a battery 160 may be coupled to the processor 110, wherein the battery 160 may supply power to the processor 110 and various other modules and components located on the mobile device 100 through appropriate circuitry and/or under control of the processor 110.

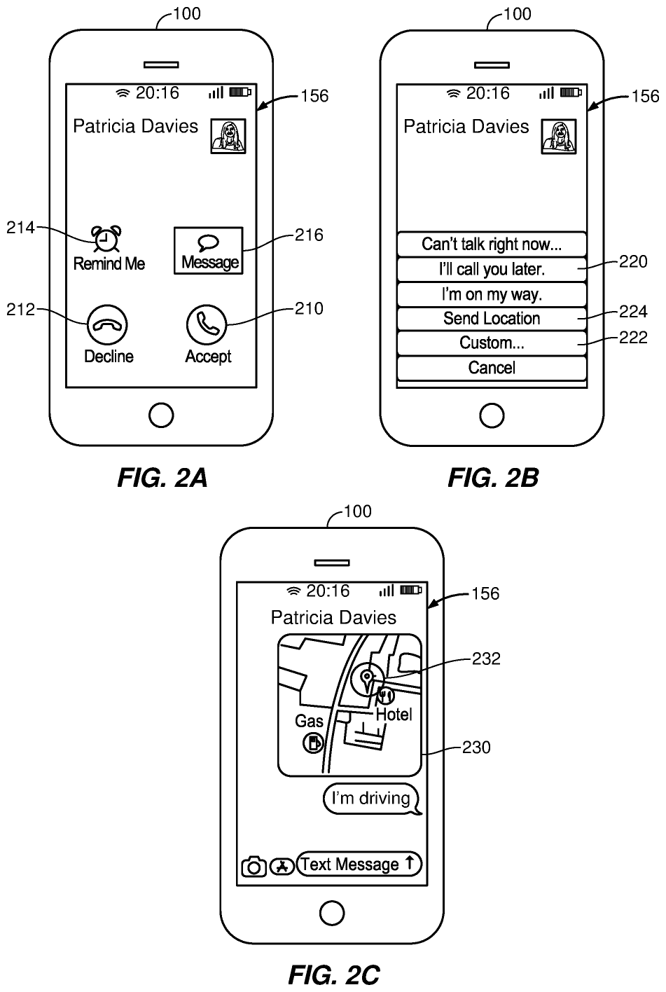

The positioning module 128 can be capable of determining a position based on inputs from wireless signal measurements from WWAN transceiver 104, signal measurements WLAN transceiver 106, data received from SPS receiver 108, and/or data from motion sensor 112. The positioning module 128 can also include, or have access to, positioning memory 130 in memory 114 for storing a latest known position of the mobile device in accordance with, for example, FIG. 2C.

The map application 132 can be capable of generating an image of a map of an area surrounding the position determined by the positioning module 128 above. Additionally or alternatively, the map application 132 can be capable of generating an image of a map of an area surrounding any given position based on the map application receiving coordinates of a location. To generate the image, using the computed or received coordinates, the map application 132 can access data from a map server (not illustrated) via, for example, WWAN transceiver 104 or WLAN transceiver 106. The image generated can then be displayed on display 156 or can otherwise be used as described herein. For example, the image of the map can be location information that is sent in a text message as described elsewhere herein.

While the modules shown in FIG. 1 are illustrated in the example as being contained in the memory 114, it is recognized that in certain implementations such procedures may be provided for or otherwise operatively arranged using other or additional mechanisms. For example, all or part of the positioning module 128 may be provided in firmware. Also, some aspects of positioning module 128 may be performed in WWAN transceiver 104.

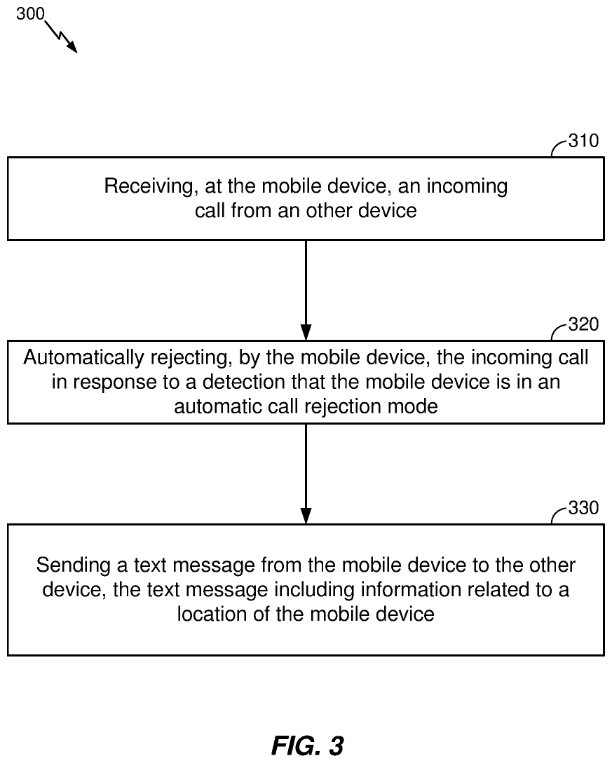

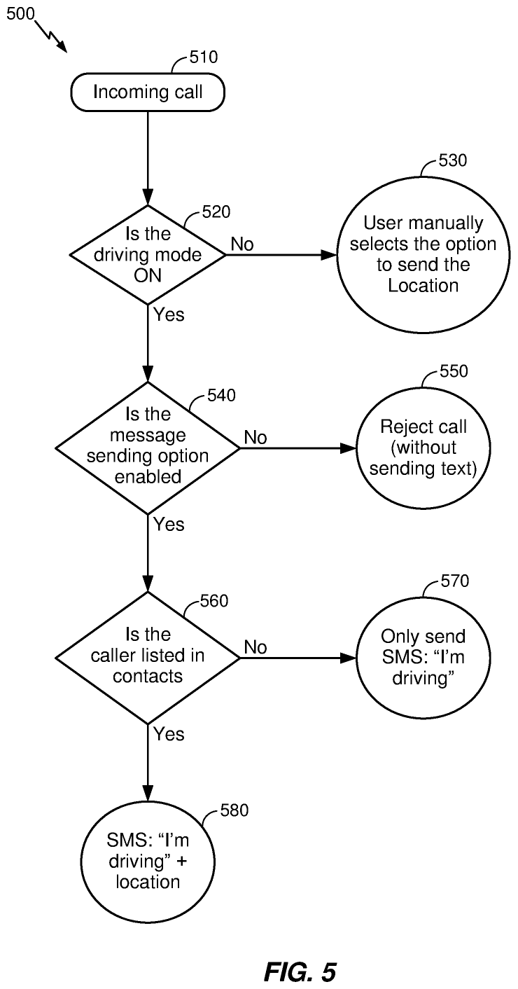

In many embodiments, the memory 114 can include many different kinds of memory and is only illustrated schematically. Memory 114 can include a non-transitory computer readable medium, which may include a read-only memory (ROM) device. The memory 114 may comprise software elements, including an operating system, device drivers, executable libraries, and/or other code, such as the illustrated map application 132. Merely by way of example, one or more procedures described with respect to the method(s) discussed below might be implemented as code and/or instructions for execution by the mobile device 100 (and/or one or more processors of the mobile device 100), in an aspect, then, such code and/or instructions may be used to configure and/or adapt a general purpose computer (or other device) to perform one or more operations in accordance with the described methods with reference, for example, to FIGS. 3 and 5.

The mobile device 100 may include a user interface 150, which provides any suitable interface systems, such as a microphone/speaker 152, keypad 154, and display 156 that allows user interaction with the mobile device 100. The microphone/speaker 152 provides for voice communication services using the WWAN transceiver 104 and/or the WLAN transceiver 106. Additionally, the microphone/speaker 152 can provide audio-based navigation instructions as described above. Although illustrated as a single device, it is understood that microphone/speaker 152 may comprise a separate microphone device and a separate speaker device. The keypad 154 comprises any suitable buttons for user input. The display 156 comprises any suitable display, such as, for example, a liquid crystal display, and may further include a touchscreen display for additional user input modes. The user interface 150 is illustrated as a hardware user interface 150, however, can also be understood to include a graphical user interface displayed on a touchscreen (for example, integrated with display 156) allowing output to a user and receipt of input from the user. Input from, and output to, user can be mediated through the user interface 150 such that the mobile device, for example the processor 110 or other components, can receive user input from the user interface 150 and provide output to the user to the user interface 150.

The processor 110 may include any form of logic suitable for performing at least the techniques provided herein, for example any of the methods or aspects described with reference to FIGS. 2A, 2B, 2C, 3, 4 and 5. In one particular example, the processor 110 can be configured to automatically reject the incoming call in response to a detection that the mobile device is in an automatic call rejection mode, generate a text message including information related to a location of the mobile device, and send the text message, via a transceiver, for example the WWAN transceiver, to the other device. To reject the call, the processor 110 can, for example, reject the call through the CM layer 410 or SM layer 414 with reference to FIG. 4. The processor 110 can be configured to, for example, automatically reject the incoming call. For example, the automatic rejection of the incoming call can be responsive to a determination that the mobile device is in a driving mode, a power saving mode, a national roaming or international roaming call rejection mode, or any combination thereof. For example, the processor 110 can be configured to instruct the WWAN transceiver to send the text message responsive to a determination that a phone number associated with the other device is included in a contact list of the mobile device. In one particular example, the processor 110 configured to automatically reject the incoming call from the other device comprises the processor 110 configured to display, via a user interface (such as user interface 150 and/or display 156) one or more options associated with automatically rejecting the incoming call, and receiving from the user interface a selection of an option of the one or more options associated with automatically rejecting the incoming call. Responsive to receiving the selection from the user interface, the processor may perform steps associated with the selecting in addition to automatically rejecting the call.

FIGS. 2A, 2B, and 2C illustrate an example of a display of a mobile device, such as mobile device 100 with reference to FIG. 1, such as when the mobile device 100 is receiving an incoming call from another, calling, mobile device (for example, as illustrated, a device having a phone number saved in the contact directory of the mobile device under the name “Patricia Davies”). It is understood that both the (or mobile terminating) mobile device, illustrated here as mobile device 100, and the other (or mobile originating) device can both be wireless mobile devices. However, for ease of discussion, the calling device will be referred to as the other device in this specification.

As shown in FIG. 2A, mobile device 100 is receiving a call from an other device. The user is presented with a plurality of options for dealing with the call on a display of the mobile device 100, such as display 156, by means of icons. A calling application on the mobile device can, through a user interface, such as user interface 150 with reference to FIG. 1, instruct that image data be displayed on the display 156 to allow for interaction of the user with the icons in the image. Where the display 156 is a touch screen display, as illustrated here, the user can select an icon displayed on the display 156 by touching the screen at a location corresponding to the icon.

As illustrated in FIG. 2A, the user may choose to accept the call by pressing icon 210 or the user may choose to decline the call by pressing icon 212. Additionally, in some implementations, the user may be given additional choices in reacting to the call. For example, by touching icon 214, labeled “Remind Me,” the user may reject the call, but receive a reminder message some time later to return the call or listen, for example, to a voice message left by the other caller who initiated the call being rejected. The reminder may come at a certain user-defined time after rejecting the call. Another example option available to the user for responding to the call includes touching icon 216, labeled “Message.” Selection of such an icon could, for example, indicate to the mobile device 100 that the user wishes to manually reject the call, but to send a message to the other device.

In the illustrated examples of FIGS. 2A and 2B, presume that the user has touched the display 156 in a location on the display corresponding to the icon 216 such that a user interface, for example user interface 150 with reference to FIG. 1, receives a selection of icon 216. Icon 216 represents an indication by the user that the user would like to respond to the incoming phone by rejecting the call and responding with a text message. The display 156 then could display a further set of icons to allow the user to select a desired message to send in response to the call. Such an example set of icons is displayed in FIG. 2B. As illustrated in FIG. 2B, after selecting icon 216 illustrated in FIG. 2A in which the user indicates a desire to reject the incoming call and send a message to the other device, the user is presented with choices regarding what kind of message to send to the other device. In the implementation depicted in FIG. 2B, a message will be sent beginning with “Can't talk right now,” with the remainder of the message to be chosen by the user. For example, by selecting icon 220, “I'll call you later,” the user would indicate a desire to send a text message that reads “Can't talk right now, I'll call you later.” In another example, a user may choose icon 222, “Custom,” in which case, the user will be provided with a virtual keyboard displayed on the touchscreen display to type out a custom message of the user's choice on the screen. Although the discussion above references FIG. 2B appearing after icon 216 of FIG. 2A is selected, it is understood that in a scenario where an incoming call is automatically rejected, FIG. 2B may, for example, appear directly without a user selecting icon 216 since in such an automatic rejection mode, the mobile device will automatically reject the call and, in such a case, icons 220, 222, and 224 simply allow the user to select what text message to send to the other device initiating the call. Hence, in an automatic rejection scenario, FIG. 2B illustrates the mobile device displaying, via a user interface such as display 156, one or more options associated with automatically rejecting the incoming call, for example, icons 220, 222, and 224. When a user selects one of the options, the mobile device receives from the user interface a selection of an option of the one or more options associated with automatically rejecting the incoming call. Responsive to the selection of the option, the mobile device may then send a message or take additional or alternative action, after having automatically rejected the incoming call, based on the selected option.

The options regarding a message to send to the other device illustrated in FIG. 2B includes icon 224, indicating that the user may send location. In a situation where the user selects the “Send Location” icon 224, one text message saying “Can't talk right now,” or something similar, can be sent along with, in the same or another text message, information related to or indicating a location of the mobile device 100, as illustrated in FIG. 2C. For example, as shown in FIG. 2C, the information related to or indicating a location of the mobile device can include map 230, shown here on the screen as having been sent to the other device (the other device associated with saved contact “Patricia Davies”) along with text message “I'm driving.” The map 230 also includes a pin 232 or other indication of the location (for example, a last known location) of the mobile device on the map. In this example, where the information related to or indicating the location of the mobile device includes both text and an image, for example, map 230, it is understood that the text can be sent over CS or PS signaling while the image (such as map 230) can be sent over PS signaling.

The text message sent by the mobile device 100 can be sent, for example, as an SMS message. Additionally or alternatively, the text message can be sent over CS signaling. The information related to the location of the mobile device 100 can include, in one example, text indicating the coordinates of the location of the mobile device 100, for example, in degrees, minutes, seconds (DMS) format; degrees and decimal minutes (DMM) format; or decimal degrees (DD) format. The other device that receives the text indicating the coordinates of the location of the mobile device 100 may have software, such as mapping software (similar to map application 132 discussed above with reference to FIG. 1), that may recognize the DMS, DMM, and/or DD format as a location, and hence the text may be displayed on the other device as a link which the user of the other device can touch, such touch then launching the map application to allow the user to see a map of the location indicated by the text. Additionally or alternatively, the information related to the location can include an image, such as an image of a map 230 with reference to FIG. 2C, with an indication on the image of the map of the location (for example, a last known location) of the mobile device. The image of the map can be generated using, for example, map application 132 with reference to FIG. 1. In various implementations, FIG. 2B may be displayed to allow a user to select, for example, icon 224. However, in other implementations, the text message including information related to a location of the mobile device may be sent automatically after rejecting the call and hence a screen similar to FIG. 2B may not be displayed.

FIG. 3 illustrates an example method 300 of sending a text message from a mobile device, such as mobile device 100 with reference to FIG. 1.

Method 300 begins at block 310 with receiving, at the mobile device, an incoming call from an other device. The mobile device may also be referred to as a mobile terminating device, and the other device may also be referred to as the mobile originating device. Means for performing the functionality of block 310 can, but not necessarily, include, for example, antenna(s) 102, WWAN transceiver 104, WLAN Transceiver 106, and/or processor 110 with reference to FIG. 1 and protocol stack 400 with reference to FIG. 4.

Method 300 continues at block 320 with automatically rejecting the incoming call by the mobile device in response to a detection that the mobile device is in an automatic call rejection mode. In various examples, the automatic call rejection mode can include, for example, a driving mode, in a power saving mode, in a national roaming call rejection mode, or in an international roaming call rejection mode, or any combination thereof. For example, if the mobile device is in a driving mode, or other mode where user interaction with a mobile device can raise safety concerns, calls may be handled automatically without notifying the user of the call. Additionally or alternatively, the call may be automatically rejected due to low power remaining in the battery where the mobile device is in a power saving mode. Additionally or alternatively, the call may be automatically rejected due to the location of the mobile device being such that accepting the call will be unduly costly, such as in a national roaming call rejection mode or international roaming call rejection mode (where the national or international roaming call rejection mode can be a mode where calls are automatically rejected when a mobile device is roaming, nationally and/or internationally, to reduce roaming fees). As a part of some user setting, for example, additional steps, as described below, can be taken in addition to automatically rejecting the call.

Means for performing the functionality of block 320 can, but not necessarily, include, for example, antenna(s) 102, WWAN transceiver 104, WLAN transceiver 106, processor 110, memory 114, user interface 150, microphone/speaker 152, keypad 154, and/or display 156 with reference to FIG. 1 and protocol stack 400 with reference to FIG. 4.

Method 300 continues at block 330 with sending a text message from the mobile device to the other device, the text message including information related to a location of the mobile device. In one example, the location can be a last known location. In one example, such as, but not necessarily, when the mobile device is in a low power mode and data services are restricted, the text message can be sent using CS signaling. Although WiFi (802.11), LTE, and other similar protocols are packet-switched (PS) protocols, and therefore generally, it is understood that some kinds of text messages may not be sent using these protocols, it is also understood that SMS messages can be sent using CS signaling through LTE as described elsewhere herein (for example SMS over SGs). Hence, it is understood that even PS protocols may provide methods for sending SMS messages using CS signaling. The location of the mobile device can be obtained in various known methods for determining the position of a mobile device, including using satellite-based positioning, ground transmitter-based positioning, WiFi-based positioning, dead reckoning using sensors, and/or other positioning technologies, or any combination thereof. Generating the text message can involve a non-access stratus (illustrated in FIG. 4 as including a mobility management (MM) layer 408 and a CM layer 410 or a GPRS mobility management (GMM) layer 412 and a session management (SM) layer 414), as described further below with reference to FIG. 4.

For example, the sending of the text message can be manual or automatic. Hence, after automatically rejecting the call as described in block 310, a user can be presented, via a user interface of the mobile device, with one or more options associated with automatically rejecting the incoming call, for example, as illustrated with reference to FIG. 2B. Alternatively, in an implementation where the text message is sent automatically, in one example, sending the text message including information related to a location of the mobile device can be limited only to known numbers. Hence, in one example, block 330 is performed responsive to a determination that a phone number associated with the other device is included in a contact list of the mobile device. The information related to the location of the mobile device that is sent in the text message can include, as described with reference to FIGS. 2A, 2B, and 2C, a textual representation of location coordinates associated with the location of the mobile device. The textual representation can include American Standard Code for Information Interchange (ASCII) characters, GSM character set characters, Unicode characters, Hyper Text Transfer Protocol (HTTP) encoded characters. The location coordinates can include different formats, such as, for example, degrees, minutes, and seconds (DMS) (example: 41° 24′12.2″N 2° 10′26.5″E), degrees and DMM (example: 41° 24.2028′, 2° 10.4418′), or decimal degrees (DD) (example: 41.40338, 2.17403). In addition to the text message of block 330, the method may further include sending an image of a map (indicating the location) generated by, with reference to FIG. 1, the positioning module 128 using, for example, signals from the SPS receiver 108 and/or other (including, for example, terrestrial RF) sources, on the mobile device. Hence, in an example where the text message includes text only and is sent over CS signaling using, for example, SMS, it is understood that a map (which includes an image) may be sent using a different service, for example a multimedia message service (MMS) over PS signaling, even though the map may be displayed along side the text as illustrated in FIG. 2C.

It is understood that, although not illustrated in FIG. 3, the method 300 may further include determining, by the mobile device, the location of the mobile device. The location can, in some examples, be periodically determined by, for example, positioning module 128 with reference to FIG. 1 using signals received by WWAN transceiver 104, WLAN transceiver 106, SPS receiver 108, and/or motion sensor 112, or any combination thereof. In some examples, the position can be determined using the processor 110 using inputs received from various components of the mobile device.

In one example, block 330 can include generating a text message including information related to the location of the mobile device in order for mobile device to send the text message to the other device. In situations where an SMS text message is input by a user using a touchscreen or keypad, and the SMS text message is to be sent through CS signaling, with reference to FIG. 4, the applications processor (such as processor 110 with reference to FIG. 1), using the CM layer 410 initiates a connection with the MM layer 408 which can encode it as a message to be then handled by the Radio Resource Control (RRC) layer 406. Hence, in a situation where the CS text message is to be automatically generated by a processor, such as processor 110 with reference to FIG. 1, without user input (for example, when automatically rejecting a call and automatically sending a text message), the processor can generate the message which can then be prepared for transmission using protocol stack 400 of FIG. 4.

Means for performing the functionality of block 330 can, but not necessarily, include, for example, antenna(s) 102, WWAN transceiver 104, WLAN transceiver 106, SPS receiver 108, processor 110, motion sensor 112, and/or memory 114 with reference to FIG. 1 and protocol stack 400 with reference to FIG. 4.

FIG. 4 illustrates an example protocol stack 400, here a Universal Mobile Telecommunications System (UMTS) signaling protocol stack, for communicating using a wireless communications network via, for example, WWAN transceiver 104 with reference to FIG. 1 and implementable in software and firmware in hardware devices such as the WWAN transceiver 104, the WLAN transceiver 106, and/or processor 110 with reference to FIG. 1. As shown, the protocol stack includes multiple access stratum layers and multiple non-access stratum (NAS) layers. The access stratum layers include a physical layer (PHY layer) 402, medium access control (MAC) layer 403 and radio link control (RLC) layer 404, and a RRC layer 406. PHY layer 402 is configured to demodulate and error check data received through the air interface and transfer the data to the MAC layer 403. PHY layer 402 is also configured for sending data received from higher layers by adding channel coding, rate matching, frequency upconversion, and finally sending it to antenna(s) 102 to radiate to, for example, base stations. The MAC layer 403 is configured to feed data received from the PHY layer 402 to control or data channels and adds redundancy checks to validate the received bits from the network. In transmission, the MAC layer 403 formats the data received from higher layers for sending to PHY layer 402 to be transmitted. RLC layer 404 provides flow control for data received from the MAC layer 403. It can strip headers from and/or reorder data received from the MAC layer 403 to form data packets for higher layers. It can also send control data to the RRC layer 406. The RRC layer 406 establishes a call based on the control data it receives from the RLC layer 404. The RRC layer 406 can also be involved in initiate handovers between various wireless technologies.

The NAS layers are shown as divided into two kinds, circuit-switched (CS) and packet-switched (PS). The CS NAS includes a MM layer 408 and a CM layer 410. As such, means for sending a text message using CS signaling can include the MM layer 408 and the CM layer 410, as well as the PHY, MAC, RLC, and RRC layers 402, 403, 404, and 406. The PS NAS includes a General Packet Radio Service (GPRS) mobility management (GMM) layer 412 and a SM layer 414. Data the MM layer 408 receives from the RRC layer 406 is used to establish a call. When transmitting data, the MM layer 408 is responsible for initiating SMS messaging and provides the RRC layer 406 instructions on what CS operation to perform. The CM layer 410 can receive data from the MM layer 408 and interact with the applications processor, for example, processor 110 with reference to FIG. 1, to, for example, display information and receive feedback from the user, including, for example, SMS message information when the SMS message information is sent or received using CS signaling. When data for a voice call or SMS message is transmitted or received using PS signaling, the data is handled by the GMM layer 412 and the SM layer 414. The lower layers (RRC/RLC/MAC/PHY) receive the data, for, for example, the contents of an SMS message. The MAC layer 403 and/or the PHY layer 402 add headers for the SMS message to enable transmission over the air. Similarly, when rejecting a call, the NAS sends an indication to reject the call to the lower layers.

FIG. 5 illustrates an example method 500 of implementing method 300 of FIG. 3. Method 500 begins at block 510 with an incoming call. At block 520, a determination is made regarding whether, in this example, a driving mode is on. However, it is understood that other modes, such as a power saving mode, for example, may additionally or alternatively be used. Other examples of scenarios where automatic call rejection may be useful include national roaming or international roaming automatic call rejection mode where accepting a call would result in high charges, but where a text message would be more cost effective than a voice call. Hence, at block 520, in one example, the determination may be made as to whether the mobile device is in any of a driving mode, a power saving mode, a national roaming automatic call rejection mode, or an international roaming automatic call rejection mode, or any combination thereof. As shown, responsive to a determination that the driving mode is not on (“No”), the user can optionally, if user wishes, manually select to send a location (as discussed with reference to FIG. 2B) at block 530. Otherwise, responsive to a determination that the driving is on (“Yes”), the method 500 moves to block 540. At block 540, a determination is made regarding a message sending option being enabled. In one example, such a user-selectable option could be a setting in the mobile device indicating the user's desire to send messages when automatically rejecting calls due to being in the driving mode. Responsive to a determination that the message sending option is not enabled (“No”), the method 500 moves to block 550 where the call is rejected. On the other hand, responsive to a determination that the message sending option is enabled (“Yes”), the method moves to block 560. At block 560, a determination is made regarding the number associated with the other device. Responsive to a determination that the other device is not associated with a number that is known to the mobile device, in this example, if the number is not listed in the contacts stored on the mobile device, the method 500 moves to block 570. At block 570, the call is rejected and a text message, for example an SMS message, is sent without location and with text indicating that the user of the mobile device is driving. Otherwise, responsive to a determination that the other device is associated with a number that is known to the mobile device, in this example, if the number is listed in the contacts stored on the mobile device, the method 500 moves to block 580. At block 580, the call is rejected and a text message, for example, an SMS message, is sent indicating that the user of the mobile device is driving. Additionally, at block 580, information related to a location of the mobile device can be sent.

The methods, systems, and devices discussed above are examples. Various embodiments may omit, substitute, or add various procedures or components as appropriate. For instance, in alternative configurations, the methods described may be performed in an order different from that described, and/or various stages may be added, omitted, and/or combined. Also, features described with respect to certain embodiments may be combined in various other embodiments. Different aspects and elements of the embodiments may be combined in a similar manner. Also, technology evolves and, thus, many of the elements are examples that do not limit the scope of the disclosure to those specific examples.

Specific details are given in the description to provide a thorough understanding of the embodiments. However, embodiments may be practiced without these specific details. For example, well-known circuits, processes, algorithms, structures, and techniques have been shown without unnecessary detail in order to avoid obscuring the embodiments. This description provides example embodiments only, and is not intended to limit the scope, applicability, or configuration of the disclosure. Rather, the preceding description of the embodiments will provide those skilled in the art with an enabling description for implementing embodiments of the disclosure. Various changes may be made in the function and arrangement of elements without departing from the spirit and scope of the disclosure.

Also, some embodiments were described as processes depicted as flow diagrams or block diagrams. Although each may describe the operations as a sequential process, many of the operations may be performed in parallel or concurrently. In addition, the order of the operations may be rearranged. A process may have additional steps not included in the figure. Furthermore, embodiments of the methods may be implemented by hardware, software, firmware, middleware, microcode, hardware description languages, or any combination thereof. When implemented in software, firmware, middleware, or microcode, the program code or code segments to perform the associated tasks may be stored in a computer-readable medium such as a storage medium. Processors may perform the associated tasks.

It will be apparent to those skilled in the art that substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

Those of skill in the art will appreciate that information and signals used to communicate the messages described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Terms, “and” and “or” as used herein, may include a variety of meanings that also is expected to depend at least in part upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean any combination of A, B, and/or C, such as A, AB, AA, AAB, AABBCCC, etc.

Having described several embodiments, various modifications, alternative constructions, and equivalents may be used without departing from the spirit of the disclosure. For example, the above elements may merely be a component of a larger system, wherein other rules may take precedence over or otherwise modify the application of the embodiments described herein. Also, a number of steps may be undertaken before, during, or after the above elements are considered. Accordingly, the above description does not limit the scope of the disclosure.

1. A method for sending a text message from a mobile device comprising:
determining a position of the mobile device based on wireless signal measurements;
receiving, at the mobile device, an incoming call from an other device;
automatically rejecting, by the mobile device, the incoming call in response to a detection that the mobile device is in an automatic call rejection mode; and
sending the text message from the mobile device to the other device, the text message including information related to a location of the mobile device, wherein the location corresponds to the determined position of the mobile device.

2. The method of claim 1, wherein sending the text message from the mobile device to the other device comprises sending the text message using circuit-switched (CS) signaling.

3. The method of claim 1, wherein the automatic call rejection mode comprises a driving mode, a power saving mode, a national roaming call rejection mode, or an international roaming call rejection mode, or any combination thereof.

4. The method of claim 1, wherein sending the text message including the information related to the location of the mobile device is performed responsive to a determination that a phone number associated with the other device is included in a contact list of the mobile device.

5. The method of claim 1, wherein automatically rejecting the incoming call from the other device by the mobile device comprises:
displaying via a user interface one or more options associated with automatically rejecting the incoming call; and
receiving from the user interface a selection of an option of the one or more options associated with automatically rejecting the incoming call.

6. The method of claim 1, wherein the information related to the location of the mobile device comprises a textual representation of location coordinates associated with the location of the mobile device.

7. The method of claim 1, wherein the information related to the location of the mobile device comprises a map including an indication of the location of the mobile device on the map.

8. The method of claim 1, further comprising:
determining, by the mobile device, the location of the mobile device.

9. A mobile device comprising:
a transceiver configured to receive an incoming call from an other device;
a memory; and
a processor coupled with the transceiver and the memory, the processor configured to:
determine a position of the mobile device based on wireless signal measurements;
automatically reject the incoming call in response to a detection that the mobile device is in an automatic call rejection mode,
generate a text message including information related to a location of the mobile device, wherein the location corresponds to the determined position of the mobile device, and
send the text message, via the transceiver, to the other device.

10. The mobile device of claim 9, wherein the processor configured to send the text message to the other device comprises the processor configured to send the text message using circuit-switched (CS) signaling.

11. The mobile device of claim 9, wherein the automatic call rejection mode comprises a driving mode, a power saving mode, a national roaming call rejection mode, or an international roaming call rejection mode, or any combination thereof.

12. The mobile device of claim 9, wherein the processor is configured to send the text message to the other device responsive to a determination that a phone number associated with the other device is included in a contact list of the mobile device.

13. The mobile device of claim 9, wherein the processor configured to automatically reject the incoming call comprises the processor configured to:
display via a user interface one or more options associated with automatically rejecting the incoming call; and
reject the incoming call responsive to receiving from the user interface a selection of an option of the one or more options associated with automatically rejecting the incoming call.

14. The mobile device of claim 9, wherein the information related to the location of the mobile device comprises a textual representation of location coordinates associated with the location of the mobile device.

15. The mobile device of claim 9, wherein the information related to the location of the mobile device comprises a map including an indication of the location of the mobile device on the map.

16. The mobile device of claim 9, further comprising:
a positioning module configured to determine the location of the mobile device.

17. An apparatus for sending a text message from a mobile device comprising:
means for determining a position of the mobile device based on wireless signal measurements;
means for receiving, at the mobile device, an incoming call from an other device;
means for automatically rejecting, by the mobile device, the incoming call in response to a detection that the mobile device is in an automatic call rejection mode; and
means for sending the text message from the mobile device to the other device, the text message including information related to a location of the mobile device, wherein the location corresponds to the determined position of the mobile device.

18. The apparatus of claim 17, wherein the means for sending the text message from the mobile device to the other device comprises means for sending the text message using circuit-switched (CS) signaling.

19. The apparatus of claim 17, wherein the automatic call rejection mode comprises a driving mode, a power saving mode, a national roaming call rejection mode, or an international roaming call rejection mode, or any combination thereof.

20. The apparatus of claim 17, wherein the means for sending the text message including the information related to the location of the mobile device comprises means for sending the text message responsive to a determination that a phone number associated with the other device is included in a contact list of the mobile device.

21. The apparatus of claim 17, wherein the means for automatically rejecting the incoming call comprises:
means for displaying via a user interface one or more options associated with automatically rejecting the incoming call; and
means for receiving from the user interface a selection of an option of the one or more options associated with automatically rejecting the incoming call.

22. The apparatus of claim 17, wherein the information related to the location of the mobile device comprises a textual representation of location coordinates associated with the location of the mobile device.

23. The apparatus of claim 17, wherein the information related to the location of the mobile device comprises a map including an indication of the location of the mobile device on the map.

24. The apparatus of claim 17, further comprising:
means for determining the location of the mobile device.

25. A non-transitory computer readable medium storing instructions for execution by one or more processors of a mobile device to perform operations comprising:
determining a position of the mobile device based on wireless signal measurements;
receiving, at the mobile device, an incoming call from an other device;
automatically rejecting, by the mobile device, the incoming call in response to a detection that the mobile device is in an automatic call rejection mode; and
sending a text message from the mobile device to the other device, the text message including information related to a location of the mobile device, wherein the location corresponds to the determined position of the mobile device.

26. The non-transitory computer readable medium of claim 25, wherein sending the text message from the mobile device to the other device comprises sending the text message using circuit-switched (CS) signaling.

27. The non-transitory computer readable medium of claim 25, wherein sending the text message including the information related to the location of the mobile device is performed responsive to a determination that a phone number associated with the other device is included in a contact list of the mobile device.

28. The non-transitory computer readable medium of claim 25, wherein automatically rejecting the incoming call from the other device by the mobile device comprises:
displaying via a user interface one or more options associated with automatically rejecting the incoming call; and
receiving from the user interface a selection of an option of the one or more options associated with automatically rejecting the incoming call.

29. The non-transitory computer readable medium of claim 25, the operations further comprising:
determining, by the mobile device, the location of the mobile device.
